(19) United States
(12) Patent Application Publication
(10) Pub. No.: US 2006/0242887 A1
(43) Pub. Date: Nov. 2, 2006

(54) Asymmetrically oscillating lure for freshwater fish

(76) Inventor: Robert N. Toman, Clackamas, OR (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/121,822

(22) Filed: May 2, 2005

(51) Int. Cl. A01K 85/10; A01K 85/00

(52) U.S. Cl. 43/42.19

(57) ABSTRACT

In one of many possible embodiments, the present asymmetrically oscillating blade for freshwater angling includes a body between sizes 00 and 13, having a first substantially planar surface and a second substantially planar surface, wherein the first substantially planar surface and the second substantially planar surface converge to form an internal angle, and wherein the blade is configured to asymmetrically oscillate around a shaft when translated through water.

### BACKGROUND

Conventional spinner blades, such as those designated by the names “Colorado”, “Indiana”, “French”, and others, are well known and widely utilized in the fishing lure manufacturing industry. Numerous styles and sizes of spinning lures are currently manufactured utilizing these spinner blades. They include a broad range of spinner baits for black bass, jig spinners of all sizes for attachment to fishing jigs, and in-line spinners for species from sunfish and trout to large fresh and saltwater species.

While conventional spinner blades commonly utilized are numerous in sizes and shapes, they are all still basically the same in design; that is, they are primarily a shaped disc which is convex when viewed from one broad side and concave when view from the opposite broad side. These traditional spinner blades are characterized by a cross-sectional profile having a constant radius. Typically, the blade is attached to the spinning lure at its longitudinal apex by way of a hole in the blade or a clevis coupling the blade to the wire base of the spinning lure.

The concave/convex nature of the blades causes them to rotate or spin when operatively affixed to a fishing lure and pulled through the water. The reason these spinner blades are effective in attracting fish and causing them to strike is essentially unknown, but it is widely conjectured that the response is triggered by flash, vibration, sound, movement, or numerous other attributes of the specific assembly that may simulate crippled fish. Regardless of what makes spinners effective, they are widely and successfully used.

Recently a number of angling sports have increased in popularity. Specifically, a number of tournaments have been organized and televised for large mouth bass and other freshwater fish species. With the increase in popularity of fishing for freshwater fish, multiple lures have been designed to try to draw the freshwater fish away from their cover. However, traditional lures are limited to the vibrations and presentation of the conventional spinner blades.

### SUMMARY

In one of many possible embodiments, an asymmetrically oscillating blade includes a body having a first substantially planar surface and a second substantially planar surface, wherein the first substantially planar surface and the second substantially planar surface converge to form an internal angle, and wherein the blade is configured to asymmetrically oscillate around a shaft when translated through water.

According to one exemplary embodiment, an asymmetrically oscillating blade configured for freshwater fish is between approximately ⅛ of an ounce (oz.) and one and a half oz. and has a size of between 00 and 13.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a fishing tackle assembly, according to one exemplary embodiment.

FIG. 2 is an asymmetrically oscillating fishing lure, according to one exemplary embodiment.

FIG. 3-1 illustrates a top view of an angled blade, according to one exemplary embodiment.

FIG. 3-2 illustrates a cross sectional view of the angled blade of FIG. 3-1 taken along section C-C, according to one exemplary embodiment.

FIG. 4 illustrates an asymmetrically oscillating fishing lure in a first position, according to one exemplary embodiment.

FIG. 5 illustrates an asymmetrically oscillating fishing lure in a second position, according to one exemplary embodiment.

FIG. 6 illustrates an asymmetrically oscillating fishing lure in a third position, according to one exemplary embodiment.

FIG. 7 illustrates the angular velocity of an asymmetrically oscillating fishing lure with respect to time, according to one exemplary embodiment.

FIG. 8 illustrates a spinner lure, according to one exemplary embodiment.

Throughout the drawings, identical reference numbers designate similar, but not necessarily identical, elements.

### DETAILED DESCRIPTION

An asymmetrically oscillating angled blade, and a number of lure assemblies that incorporates the asymmetrically oscillating angled blade are described herein. More particularly, the present system and method includes a fishing lure having a blade with a first substantially planar face and a second substantially planar face. The first face and the second face of the present fishing lure meet to form an internal angle of between 139 and 159 degrees. According to the present exemplary embodiment, the internal angle may vary the asymmetrical oscillation to better accommodate different fishing situations. Further, the gage and/or material of the asymmetrically oscillating angled blade may be modified to vary the retrieval rate used to produce a desired oscillation rate.

In the following description, for purposes of explanation, numerous specific details are set forth in order to provide a thorough understanding of the asymmetrical oscillating lure. It will be apparent, however, to one skilled in the art, that the present system and method may be practiced without these specific details. Reference in the specification to “one embodiment” or “an embodiment” means that a particular feature, structure, or characteristic described in connection with the lure is included in at least one embodiment of the system and method. The appearance of the phrase “in one embodiment” in various places in the specification are not necessarily all referring to the same embodiment.

Fishing Tackle Assembly

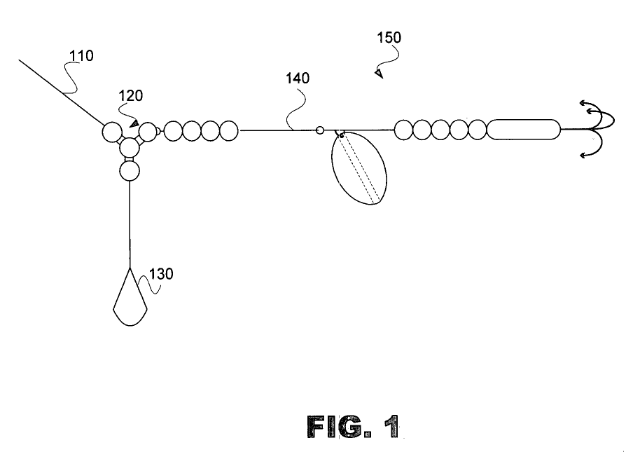

FIG. 1 illustrates an in-line fishing tackle assembly (100), according to one exemplary embodiment. As seen in FIG. 1, the fishing tackle assembly (100) generally includes a main line (110) coupled to a three-way swivel (120) or spreader, a weight (130) coupled to the three-way swivel (120) or spreader, a leader (140) coupled to the three-way swivel (120), and an asymmetrically oscillating lure (150) coupled to the leader (140).

The fishing tackle assembly (100) is moved through the water in order to maintain the asymmetrical oscillating lure (150) at a desired depth in the water so as to present the fishing tackle assembly (100) to fish that may be present at that desired depth. In particular, the weight (130) tends to draw the asymmetrically oscillating lure (150) toward the bottom of a body of water while the operation of the lure (150) tends to cause the lure to rise somewhat toward the surface. The tendency of the lure (150) to oscillate and subsequently rise to the surface depends on several factors, such as the size and shape of the blade of the lure and the rate at which the fishing tackle assembly (100) is drawn through the water. More specifically, the faster the fishing tackle assembly (100) is drawn through the water, the more the lure (150) tends to oscillate and rise. Traditional spinning lures have been limited in their oscillation by the trolling speed of the boat or the retrieval rate of the fisherman using the lure. More specifically, traditional lures will not oscillate at very slow trolling or retrieval rates. Consequently, light weight and thin materials have traditionally been used to form the components of spinning lures to facilitate oscillation. However, by reducing the weight of the material making up the traditional spinning lures, the presentation of the oscillation to the fish is similarly reduced.

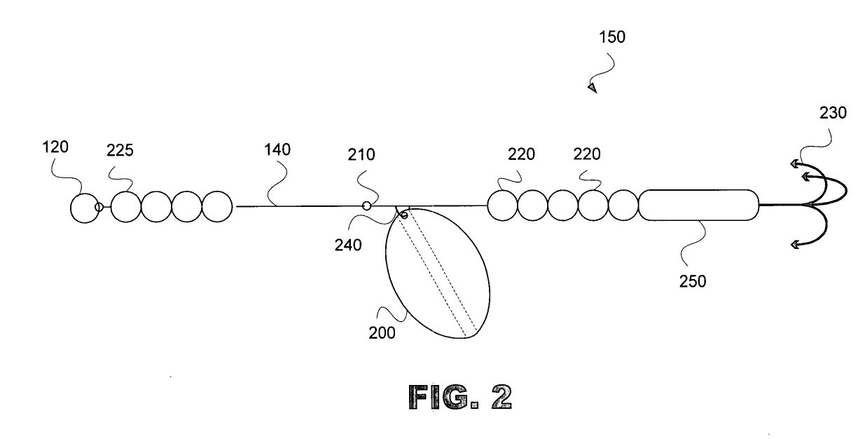

As introduced previously, one end of the main line (110) is coupled to the three-way swivel (120) and another end of the main line (110) is coupled to a rod and reel as operated by a fisherman. Movement or vibration occurring in other parts of the fishing tackle assembly (100) is transmitted through the main line (110), where it is perceived by the fisherman. These vibrations or movements indicate the operation of the fishing tackle assembly (100). The specific operation of an asymmetrically oscillating fishing lure will now be discussed in further detail with reference to FIG. 2.

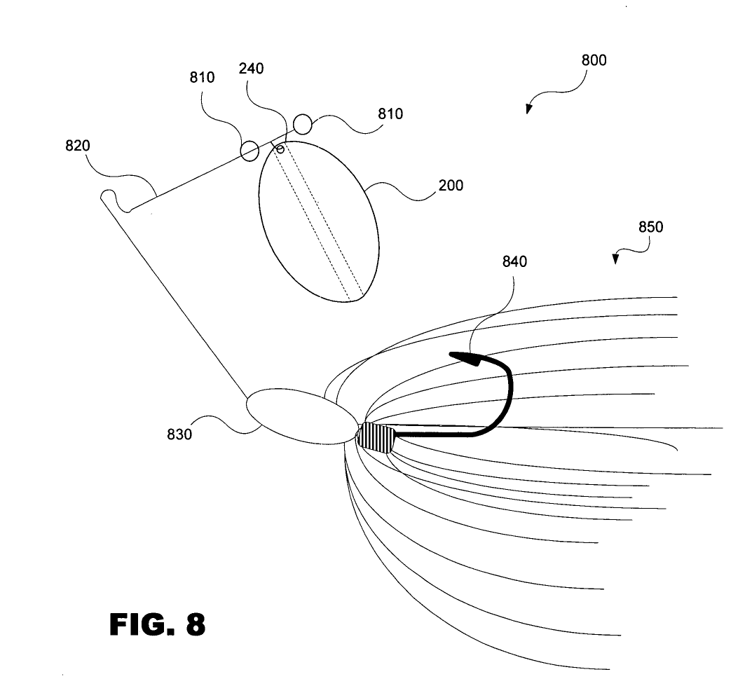

For ease of explanation only, the structure of the present asymmetrically oscillating lure will be described in the context of a specific lure configuration. However the teachings and methods of the present asymmetrically oscillating lure may be applied to any number of lure configurations, as illustrated in FIG. 8.

Asymmetrically Oscillating Fishing Lure

FIG. 2 illustrates an asymmetrically oscillating lure (150) in more detail. As illustrated in FIG. 2, the asymmetrically oscillating lure (150) includes an angled blade (200) or clevis (240), coupled to a shaft (210), a plurality of beads (220) used for attraction and bearing purposes, a bead chain swivel (225), and a hook (230). The angled blade (200) is shaped to oscillate asymmetrically. The specific configuration of each of several exemplary components will be discussed in more detail below.

As illustrated in FIG. 2, the angled blade (200) is coupled to the shaft (210) such that the blade (200) is able to rotate freely around the shaft (210) and against the plurality of beads (220). According to one exemplary embodiment, the angled blade (200) is coupled to the shaft (210) with a clevis (240). Those of skill in the art will appreciate that any suitable method may be used to rotatably couple the angled blade (200) to the shaft (210).

According to one exemplary embodiment, the shaft (210) includes eyelets formed on either end thereof. The eyelet on the proximal end of the shaft (210) allows the lure (150) to be coupled to a leader or main line while the eyelet on the distal end of the shaft (210) allows the hook (230) to be securely coupled to the shaft (210). As shown in FIG. 2, a sleeve (250) may be placed where the end of the shaft (210) is coupled to the hook (230). According to one exemplary embodiment, the sleeve (250) may maintain the hook (230) in a desired position relative to the shaft (210), thereby increasing the possibility that a fish attracted to the lure (150) will bite the hook (230) when biting the lure (150).

Additionally, a plurality of beads (220) or other colored objects may be coupled to the shaft (210) between the angled blade (200) and the sleeve (250) and the hook (230). The beads (260) may be of any suitable type, including, without limitation, plastic, glass, and/or metallic beads. The beads (260) may act as attractants to the fish. Moreover, a bead chain swivel (225) may also be disposed on the leader (140) between the asymmetrically oscillating lure (150) and the three-way swivel (120). According to one exemplary embodiment, the bead chain swivel (225) may be used to prevent the main line from twisting and to keep lures running true during trolling or lure retrieval.

The hook (230) shown in FIG. 2 is a treble-type hook. Those of skill in the art will appreciate that any suitable hook may be used. For example, other suitable hooks include, without limitation, single-barbed hooks and/or siwash hooks.

As mentioned previously, catching many freshwater sport fish entails drawing the fish away from their natural cover, such as logs and/or tall grass. According to the present exemplary embodiment, several factors may contribute to attract fish to the lure (150). For example, fish may be attracted to the image and/or reflection of the lure (150) rotating asymmetrically through the water. Additionally, fish may be attracted to the site of the lure (150) as the angled blade (200) asymmetrically oscillates through the water. More specifically, as the angled blade (200) spins through the water, the rotation occurs in an asymmetric manner. This asymmetric rotation causes the blade to “thump” rhythmically as it passes through the water. This “thumping” caused by the asymmetric oscillation of the lure (150) may be detected, whether audibly or via palpable medium compression, by a fish. In contrast to the “thump” produced by the present angled blade (200), traditional blades merely vibrate due to a fairly symmetrical oscillation.

The rhythmic thumping produced by the asymmetric rotation of the angled blade (200) causes a more pronounced visual effect as the angled blade rotates while producing shock and/or sound waves which are subsequently transmitted through the water. The combination of the enhanced visual effect and the compression waves that are transmitted through the water may increase the attraction of the lure (150) to fish. Additionally, the production of the compression waves provides for the present exemplary lure to be effective in light restricted locations such as tall grass cover, or during dusk or night fishing. Further, the degree of “thump” or the degree of asymmetry associated with the rotation of the angled blade (200) may be selectively adjusted for various situations. Moreover, the present exemplary system may vary the gage of the angled blade (200) to vary the lure retrieval rate that will produce a desired oscillation, as will be discussed in more detail below.

Angled Blade

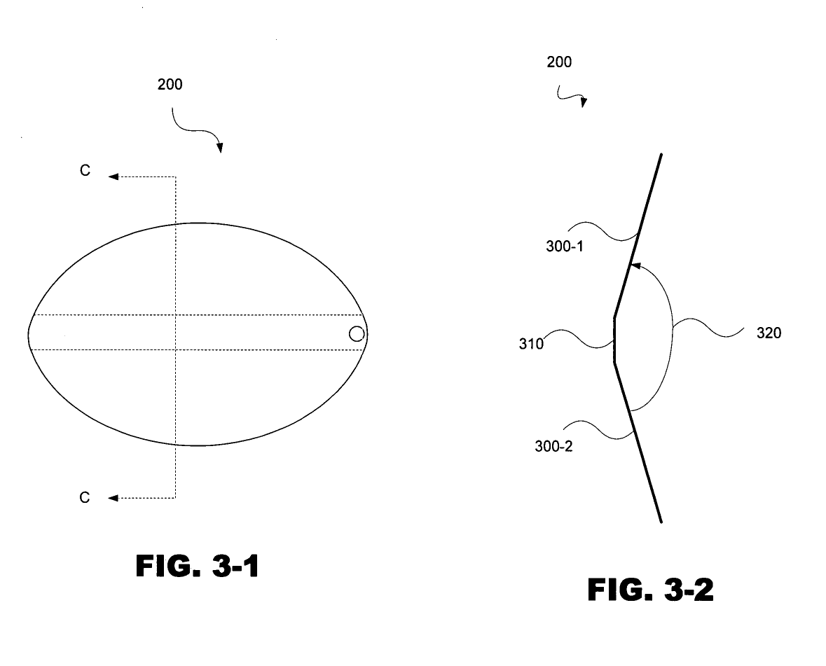

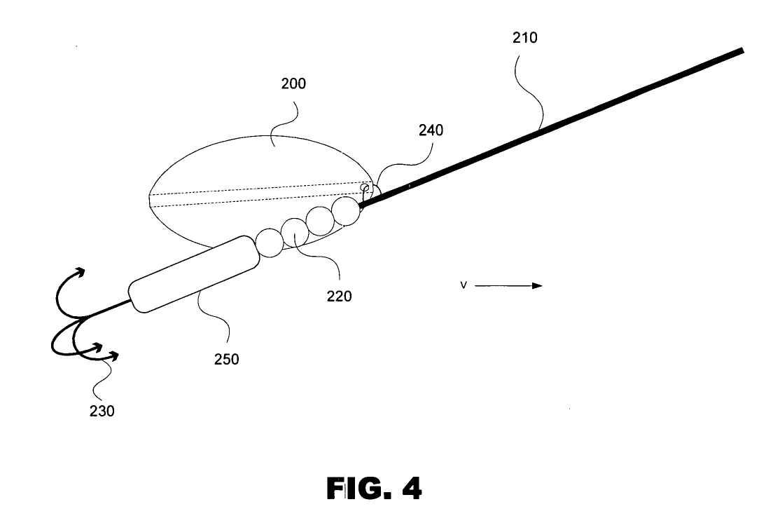

FIG. 3-1 illustrates a top view of the angled blade (200) while FIG. 3-2 illustrates a cross sectional view of the center of the angled blade (200) taken along section C-C. As seen in FIG. 3-2, the angled blade (200) includes first and second faces (300-1, 300-2) that converge at a ridge portion (310). As will be discussed in more detail with reference to FIGS. 4-6, the configuration and/or orientation of the first and second faces (300-1, 300-2) causes the angled blade (200) to oscillate asymmetrically about the shaft (210; FIG. 2) or wire arm of a lure. Selective modification of the respective configuration and/or orientation of the first and second faces (300-1, 300-2) may modify the asymmetrical oscillation of the angled blade (200) to exhibit certain desired characteristics.

An internal angle (320) is defined between the first (300-1) and second faces (300-2). By adjusting the degree of the internal angle (320), the asymmetric oscillation of the angled blade (200) may be adapted for several situations. The oscillation of the angled blade (200) will now be discussed, again with reference to a lure (150).

According to one exemplary embodiment, the angle (320) between the first (300-1) and second (300-2) faces may be between approximately 139 and 159 degrees. More specifically, according to one exemplary embodiment, the angle (320) between the first (300-1) and the second (300-2) faces is either between approximately 139 degrees and less than 147 degrees or greater than 151 degrees up to approximately 159 degrees. According to this exemplary embodiment, the internal angle (320) of the angled blade (200) may be selected based on the desired characteristics of the lure (150; FIG. 2).

For example, in some circumstances it may be desirable to provide a more pronounced asymmetric oscillation. For example, in particularly turbid water, it may be desirable to provide enhanced visual presentation and to transmit more compression waves through the liquid medium to attract the attention of fish. Similarly, when fishing at night, the optical attraction provided by the asymmetrical oscillation may be minimized and an enhanced compression wave may be desired. In such circumstances, the internal angle (320) of the angled blade (200) may assume the higher values of between approximately 151 and 159 degrees. According to this exemplary embodiment, the internal angle (320) is increased to thereby increase the orbit of the angled blade's (200) rotation. Additionally, by increasing the internal angle (320) of the angled blade (200), the angled blade will rotate at a slower trolling and/or lure retrieval rate. Additionally, the increased compression wave produced by the asymmetrical oscillation is presented to the person fishing as an increased “thump” or vibration.

In other situations, it may be desirable to somewhat reduce the asymmetric oscillation or magnitude thereof. For example, as previously introduced, the rhythm and vibration of the asymmetrically oscillating lure (150; FIG. 2) is transmitted through a main line (110; FIG. 1) back to a fisherman. Any sensed modification in the rhythm and/or vibration of the lure (150; FIG. 2) may indicate a strike by a fish. Additionally, in some circumstances, fish have been seen to bite a lure and allow it to spin in their mouth. Consequently, the slightest variation in the lure oscillation may indicate a strike. Consequently, if the fish being sought bites relatively softly, it may be desirable to somewhat reduce the thumping magnitude of the lure (150; FIG. 20), while still providing some thumping motion, such that sensation due to a fish lightly striking the lure may be more readily perceived. In such circumstances, the angle between the faces may be reduced to between approximately 147 degrees and 139 degrees. This reduction in the internal angle (320) causes the blade to have a smaller orbit and to rotate at increased trolling or lure retrieval rates.

As can be seen above, varying the internal angle of the present exemplary angled blade (200) may optimize the use of the lure (150; FIG. 2) for different applications. According to one exemplary embodiment, the internal angle of the angled blade (200) may be adjusted according to a desired retrieval rate. For example, in certain tournament fishing situations it may be desirable for an angler to be able to cast and retrieve a lure as rapidly as possible, while maintaining the desired oscillation, in order to maximize their opportunity at attracting a desired fish. Accordingly the present exemplary asymmetrically oscillating lure (150) may be designed to oscillate and attract fish at a wide range of retrieval rates.

According to one exemplary embodiment, any number of materials may be used to form the angled blade (200) including, but in no way limited to, metals such as brass, steel, stainless steel, silver, or copper; polymers; and/or composites. Additionally, according to one exemplary embodiment, the angled blade (200) of the present asymmetrically oscillating lure (150; FIG. 2) may assume any number of thicknesses or gauges including, but in no way limited to, between approximately 0.015 to 0.040 inches. According to one exemplary embodiment, the angled blade (200) is made of a material having a gauge of approximately 0.023 inches. While traditional spinning lures have been unable to effectively spin at desired trolling speeds when manufactured of material having a gauge above 0.020 inches, the present angled blade (200) not only oscillates at trolling speeds, but also produces an enhanced compression at such speeds. That is, the particular combination of a heavier blade and the shape of the present angled blade (200) permits slow trolls while increasing the “thump” or compression over traditional spinners.

According to one exemplary embodiment, the gage of the material used to form the present angled blade (200) may be varied to modify the optimal retrieval rate while maintaining a desired oscillation rate. More specifically, with increased blade gage and weight, a faster retrieval rate and increased inertia is used to generate a desired oscillation rate. Consequently, a number of angled blades (200) having varying gages and weights may be provided for a freshwater sport fisherman. As a result the sport fisherman may select a blade that corresponds to a desired retrieval rate for efficient fish catching, such as may be desirable in tournament situations.

Further, the surface of the angled blade (200) may receive designs and/or color patterns to further enhance the optical detectability of the angled blade. Exemplary designs and/or color patterns include, but are in no way limited to, colored paints, stickers, reflective coatings, and/or polished surfaces. Moreover, the size of the present exemplary angled blade (200) may vary to be adapted to various freshwater fish sizes and tendencies. More specifically, the present angled blade (200) may be produced in sizes as low as 00 (less than an inch in length) for smaller fish, to approximately size 13 for larger sport fish such as large mouth bass and walleye.

Blade Operation

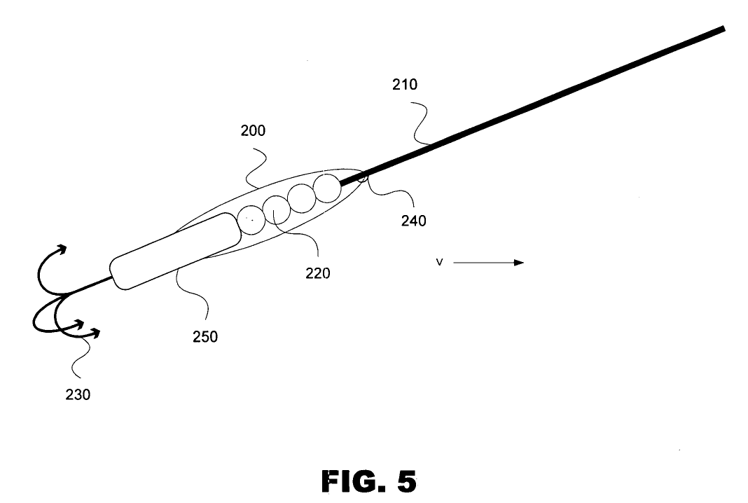

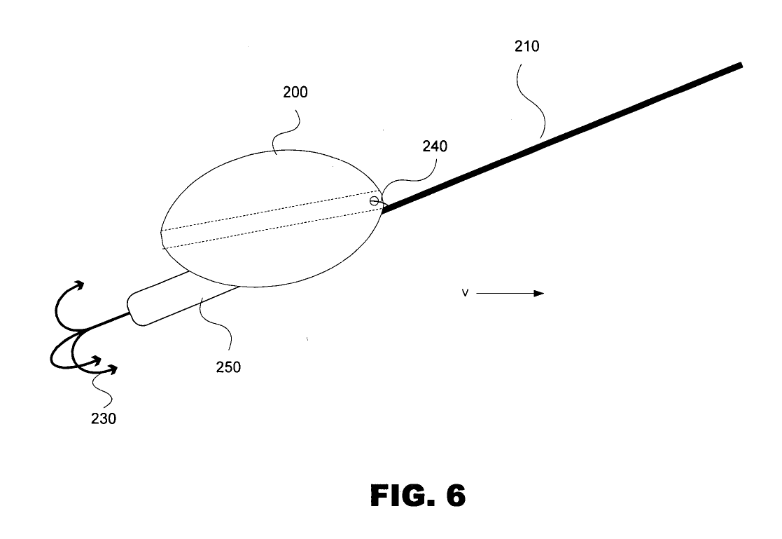

FIGS. 4-6 illustrate the oscillation of the angled blade (200) relative to the shaft (210) or wire arm as the lure (150) is drawn through a liquid medium such as water, according to one exemplary embodiment. In particular, FIG. 4 illustrates the angled blade (200) in a first position, FIG. 5 illustrates the angled blade (200) in a second position, and FIG. 6 illustrates the angled blade in a third position.

As previously introduced, when the lure (150) is drawn through the water, the angled blade (200) begins to spin. As the angled blade (200) begins to spin around the shaft, centripetal force coupled with the pinning of the angled blade to the shaft (210) causes one end of the angled blade to swing out to a first position relative to the shaft (210), as illustrated in FIG. 4. When the angled blade (200) is in this first position, the first face (300-1, FIG. 3-2) controls the subsequent angular velocity of the lure (150). In particular, water flowing against the first face (300-1, FIG. 3-2) of the angled blade (200) exerts more force on the first face (300-1; FIG. 3-2) than the force being exerted by flowing fluid on the second face (300-2; FIG. 3-2). As is illustrated in FIG. 5, the imbalance created by the different forces on the substantially flat first and second faces (300-1, 300-2; FIG. 3-2) drives the rotating angled blade (200) to rotate in an orbit that is closer to the shaft (210), as illustrated in FIG. 5.

As the angled blade (200) nears the shaft (210), its rotational velocity is increased due to a shorter radius arm. When in the second position illustrated in FIG. 5, forces exerted by water flowing over the angled blade (200) change until there is a greater force exerted on the second face (300-2, FIG. 3-2); than on the first face (300-1; FIG. 3-2). This new imbalance of force drives the angled blade (200) away from the shaft (210), as shown in FIG. 6. This increase in radial arm length results in a slower rotational velocity. Thereafter, the angled blade (200) oscillates back to the position shown in FIG. 4.

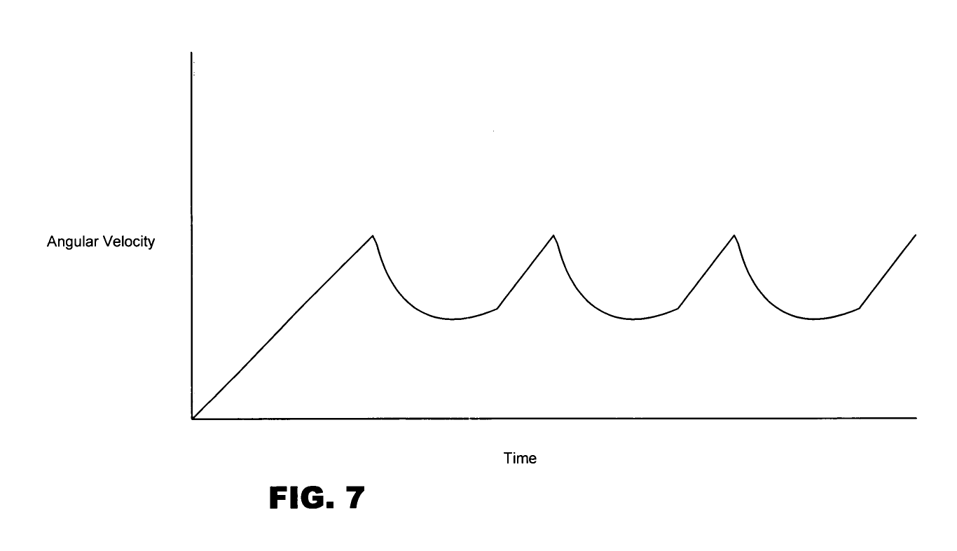

FIG. 7 graphically illustrates the angular velocity of the angled blade (200) as a function of time as the angled blade travels through water or another liquid medium. As shown in FIG. 7, the angular velocity of the angled blade (200) oscillates rhythmically between a maximum operating angular velocity and a minimum operating angular velocity. This oscillation of the angular velocity corresponds to the rhythmic “thumping” motion described above, which provides an enhanced visual presentation and increased transmitted sound or compressive waves.

Furthermore, as mentioned previously, variation of the internal angle (320; FIG. 3-2) between the first substantially planar face (300-1; FIG. 3-2) and the second substantially planar face (300-2; FIG. 3-2) may vary the intensity of the “thumping” motion. Consequently, variations in the angular velocity of the lure (150; FIG. 2) may be made by modifying the internal angle to increase or decrease the rhythmic “thumping” motion as described above.

Alternative Embodiment

As mentioned previously, the angled blade (200) including first and second faces (300-1, 300-2) that converge at a ridge portion (310) may be incorporated into any number of freshwater fish spinning lures. FIG. 8 illustrates a bass fishing lure (800) incorporating the present angled blade (200) according to one exemplary embodiment. As illustrated in FIG. 8, the exemplary spinner lure (800) includes a wire arm (820) formed in the shape of a “V.” As shown, the wire arm is coupled to at least one asymmetrically oscillating blade (200) on one side by a clevis (240). Additionally, a number of bearing beads (810) are placed on each side of the asymmetrically oscillating blade (200) to facilitate the rotation of the blade. On the opposite side of the wire arm (820), a fish attractant includes a head (830), having a hook (840) protruding there from, and a skirt (850).

According to one exemplary embodiment, a freshwater fisherman may selectively troll freshwater areas with the spinner lure (800) illustrated in FIG. 8. According to this exemplary embodiment, the internal angle and material properties of the asymmetrically oscillating blade (200) may be selected to provide the freshwater angler with a desired angular frequency and thump at a pre-determined retrieval rate, according to existing fishing conditions. The ability to modify the lure material and internal angle to match a desired retrieval rate and fishing conditions, while providing an asymmetrical oscillation and corresponding “thump” allows freshwater anglers to optimize their fish catching opportunities during bass or other freshwater angling competitions.

In conclusion, the present asymmetrical oscillating angled blade, in its various embodiments includes a fishing lure having a blade with a first substantially planar face and a second substantially planar face. The first face and the second face of the present fishing lure meet to form an internal angle of between 139 and 159 degrees. According to the present exemplary embodiment, the internal angle may vary the asymmetrical oscillation to better accommodate different fishing situations. Further, the asymmetrically oscillating blade may be formed for freshwater fishing in sizes ranging from approximately 00 to 13, and at weights of between approximately ⅛ of an ounce to approximately one and a half ounces.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. An asymmetrically oscillating blade for freshwater angling comprising:
a body including a first substantially planar surface and a second substantially planar surface;
wherein said first substantially planar surface and said second substantially planar surface converge to form an internal angle;
wherein said blade is configured to asymmetrically oscillate around a shaft when translated through water; said asymmetrically oscillating blade being sized between a 00 and an 13.

2. The asymmetrically oscillating blade of claim 1, wherein said blade comprises one of a metal, a polymer, or a composite.

3. The asymmetrically oscillating blade of claim 1, wherein said internal angle comprises between approximately 139 and 147 degrees or between 151 and 159 degrees.

4. The asymmetrically oscillating blade of claim 1, wherein said blade is configured to rotate at a varying rotational velocity around said shaft when said blade is pulled at a constant velocity through water;
said varying rotational velocity producing systematic compression waves in said water.

5. The asymmetrically oscillating blade of claim 1, wherein said body comprises a substantially oval shape.

6. The asymmetrically oscillating blade of claim 1, wherein said body further comprises an orifice on a first end;
wherein said orifice is configured to receive a coupler configured to rotatably couple said body to said shaft.

7. The asymmetrically oscillating blade of claim 1, wherein said body comprises a thickness of between approximately 0.015 and 0.040 inches.

8. The asymmetrically oscillating blade of claim 7, wherein said blade thickness is directly related to a desired lure retrieval rate.

9. A freshwater fishing lure comprising:
a shaft in the form of a V shaped wire arm;
a fish hook coupled to said shaft; and
an asymmetrically oscillating blade rotatably coupled to said shaft, said blade including a substantially oval body having a first substantially planar surface and a second substantially planar surface, wherein said first substantially planar surface and said second substantially planar surface converge to form an internal angle, wherein said blade is configured to asymmetrically oscillate around a shaft when translated through water and wherein said asymmetrically oscillating blade is sized between a 00 and an 13.

10. The fishing lure of claim 9, further comprising a plurality of beads disposed on said shaft.

11. The fishing lure of claim 9, wherein said blade comprises one of a metal, a polymer, or a composite.

12. The fishing lure of claim 9, wherein said internal angle comprises between approximately 139 and 159 degrees.

13. The fishing lure of claim 9, further comprising a plurality of asymmetrically oscillating blades coupled to said V shaped wire arm.

14. The fishing lure of claim 9, wherein said blade comprises a thickness of between approximately 0.023 and 0.040 inches.

15. The fishing lure of claim 14, wherein said blade thickness is directly related to a desired lure retrieval rate.

16. The fishing lure of claim 9, wherein said shaft comprises a V shaped wire arm, said asymmetrically oscillating blade being coupled to a first end of said V shaped wire arm;
a lure head coupled to a second end of said V shaped wire arm;
said hook being coupled to said lure head; and
a skirt coupled to said head such that said skirt partially disguises said hook.

17. The fishing lure of claim 9, wherein said blade is at least partially painted.

18. A method for forming a freshwater fishing lure comprising:
providing a lure including a shaft, a fish hook coupled to said shaft, and an asymmetrically oscillating blade rotatably coupled to said shaft, said blade being sized between a 00 and a 13, including a substantially oval body having a first substantially planar surface and a second substantially planar surface, wherein said first substantially planar surface and said second substantially planar surface converge to form an internal angle, said internal angle being between approximately 139 and 159 degrees, and wherein said blade is configured to asymmetrically oscillate around a shaft when translated through water;
varying said internal angle to provide said asymmetrical oscillation during a desired retrieval rate; and
varying a weight of said asymmetrically oscillating blade to correspond to a desired lure retrieval rate.

19. An asymmetrically oscillating blade comprising:
a body including a first substantially planar surface and a second substantially planar surface, said body being sized between approximately a 00 and an 13;
wherein said first substantially planar surface and said second substantially planar surface converge to form an internal angle of between approximately 139 and 159 degrees;
wherein said blade is configured to asymmetrically oscillate around a shaft when translated through fresh water; and
wherein said internal angle is configured to be field modified to vary said asymmetrical oscillation in response to an environment condition.
